(19) United States
(12) Patent Application Publication
(10) Pub. No.: US 2011/0240318 A1
(43) Pub. Date: Oct. 6, 2011

(54) Water Vapor Based Fire Suffocating Apparatus and Method Thereof

(76) Inventor: Charles Bradfield, Torrance, CA (US)

(21) Appl. No.: 12/750,574

(22) Filed: Mar. 30, 2010

(51) Int. Cl. A62C 31/22

(52) U.S. Cl. 169/46; 169/70

(57) ABSTRACT

A fire suffocating apparatus and method that utilizes water vapor to suffocate a fire. The fire suffocating apparatus and method utilizes a low volume of water, has a high flow rate in application, has a long-lasting effect, and can be contained in a small apparatus. The fire suffocating apparatus comprises a tank to contain water; a heating element, a temperature monitor, and thermal controller to maintain temperatures high enough to vaporize the water when it is released; a discharge tube to serve as a conduit for the vapor to escape; and a projectile to puncture a hole in the tank to allow the superheated water to flow into the discharge tube. A shell containing a plurality of holes may enclose the tank as a safety feature.

### TECHNICAL FIELD

This invention relates to a fire suffocating apparatus and method.

### BACKGROUND

Liquid water is one of the most common ways fire is currently extinguished. Water extinguishes fire by blocking access to air (oxygen). Fire can also be extinguished by diluting the air (oxygen). This is how CO₂ fire extinguishers work. The problem with the current extinguishing methods is that it requires the firefighter or user to direct the water or other fire suffocating agents directly to the fire, putting the firefighter's or user's life in danger. In addition, a lot of water or asphyxiating agent is generally required to put out fires. Furthermore, there is also the possibility that the fire can reignite due to evaporation of the water or dissipation of the asphyxiating agent.

Some extinguishers utilize water mists to conserve the amount of water utilized. However, these devices have limited ranges as the mist must be sprayed directly into the tire. In addition, when the mist evaporates and dissipates, reignition of the fire is a concern. Other extinguishers utilize gasses to asphyxiate the fire. However, these extinguishers require complicated and unnecessary structures involving the mixing of compounds prior to dousing the fire.

For the foregoing reasons there is a need for a fire suffocating apparatus that utilizes low volume of water, that has a high flow rate to dissipate through an enclosed room quickly, has a long lasting effect to prevent reignition, and can be contained in a small apparatus so as to be handheld and easily delivered.

### SUMMARY

The present invention is directed towards a fire suffocating apparatus and method that utilizes water vapor to suffocate a fire. The water is preheated in a high pressure container to a temperature which will provide instant, total vaporization when the water is released.

The container may comprise a heating element, a temperature monitor, a discharge tube to serve as a conduit for the vapor to escape, and a projectile to create a hole in the container to allow the water vapor to escape. The discharge tube comprises a plurality of holes to prevent the tank from becoming a projectile. A shell containing a plurality of holes may enclose the tank as a safety measure.

### BRIEF DESCRIPTION OF DRAWINGS

FIG. 1 shows a perspective view of an embodiment of the present invention with portions removed to show inner structures;

FIG. 2 shows a cross-section along line 2-2 from FIG. 1;

FIG. 3 shows a close-up of a cross-section of the portion identified as 3 in FIG. 1;

FIG. 4 shows a perspective view of an embodiment of the projectile; and

FIG. 5 shows a top view of the projectile shown in FIG. 4.

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

The present invention is directed towards an improved method and apparatus for suffocating a fire. The improved method of suffocating a fire utilizes water vapor to suffocate a fire. Suffocating a fire with water vapor may only require displacing approximately 50% of the oxygen in a room with the water vapor. As described herein, water vapor is the gaseous state of water that is distinguishable from liquid water, water mist, and steam that is seen as vapor condenses in the air.

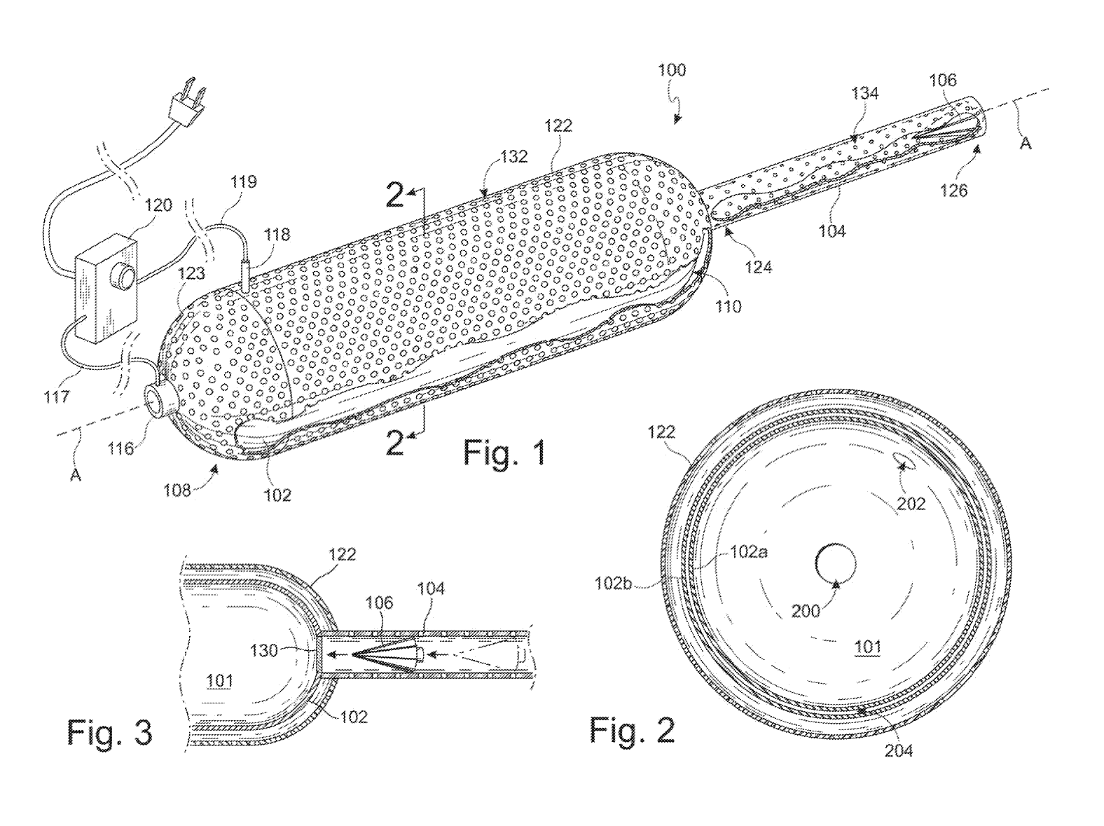

As shown in FIGS. 1 and 3, the fire suffocating apparatus 100 comprises a container 102 having a breakable area 130, a discharge tube 104 connected to the container 102, and a means for breaking the breakable area. In the preferred embodiment, a projectile 106 housed inside the discharge tube 104 capable of being propelled towards the container 102 is used to break the breakable area 130. The container 102 can be made of any type of sturdy material that can withstand temperatures of 1200° F. and pressures of up to 3200 pounds per square inch. For example, the container 102 may be a pressure container, a pressure vessel, a pressure tank, a gas cylinder, a high pressure cylinder, and the like. Examples of suitable materials for the container 102 include steel, stainless steel, carbon fiber and other composite materials. In embodiments utilizing stainless steel, a small amount of oxygen can be added inside the container to prevent rust and corrosion of the stainless steel. The container may be forged into any shape, such as a cylindrical shape. However, the container 102 may be any other shape, including but not limited to spherical, box-like, cube-shaped, pyramidal, ovoid, and the like, so long as it defines an enclosed cavity 101 to hold a fire suffocating agent, such as a fluid, at a high temperature and pressure.

In some embodiments, the container 102 may be a double-walled container as shown in FIG. 2. In the preferred embodiment, the inner wall 102a may define an enclosed cavity 101 that stores the fire suffocating agent, such as water. The outer wall 102b substantially parallels the shape of and encloses the inner wall 102a and forms a space 204 between the inner wall 102a and the outer wall 102b. A vacuum may be created in this space 204 to serve as a buffer to facilitate keeping the water inside the cavity 101 defined by the inner wall 102a at the desired temperature. In addition, the vacuum space 204 prevents the outer wall 102b from becoming exceedingly hot.

To raise and maintain the temperature of the water inside the cavity 101, the fire suffocating apparatus 100 may further comprise a means for heating the water inside the cavity 101 and a means for maintaining the water at the desired temperature. A heating element 116 may be used as a means for heating the water. An example of a heating element 116 is an immersion heater than can be inserted through an orifice 200 in the container 102 to make direct contact with the water in the cavity 101.

A temperature monitor 118, such as a thermocouple or thermostat-like device, may be used in conjunction with a temperature controller 120 as a means for maintaining the desired temperature of the water. The temperature monitor 118 can be inserted into a second orifice 202 in the container 102 to make direct contact with the water to measure the temperature of the water. This temperature reading is sent to the temperature controller 120. If the temperature reading is below the desired temperature, then the temperature controller 120 sends a signal to the heating element 116 to activate the heating element 116 and raise the temperature of the water. If the temperature of the water is at or above the desired temperature, then the temperature controller 120 can turn the heating element 116 off. In some embodiments, a pressure gauge may also be connected to the container 102 to measure the pressure inside the cavity 101.

Water can be added into the container 102, either through the first or second orifice 200 or 202 prior to the insertion of the heating element 116 or temperature monitor 118, or a third orifice (not shown) can be created through which the water can be added. A cap can be used to close the third orifice after the water has been added. In some embodiments, the breakable area 130 may also function as the cap. In the preferred embodiment, the cap is welded shut to maintain to minimize or eliminate any leaks.

To insure 100% vaporization of the water, it must be heated to a temperature of 1200° F. or higher. At that temperature, the pressure will be 3200 p.s.i. or higher.

The heating element 116 and the temperature monitor 118 each have a wire or conduit 117, 119, respectively that is operatively connected to the temperature control 120. In some embodiments, these conduits 117, 119 may be detachably connected to the heating element 116 and temperature monitor 118. This allows the conduits 117, 119 to be easily removed from the fire suffocating apparatus 100 when the fire suffocating apparatus 100 is ready to be positioned for use.

The container 102 further comprises a means for expelling the water. In some embodiments, the container 102 may comprise a breakable area 130 that can be broken with sufficient force by the projectile 106. To be sure, the term breakable is relative to the sturdiness of the container 102. Thus, the breakable area 130 may be relatively more easily broken than the rest of the container 102, but it is not a fragile area as it still needs to withstand the high temperatures and pressures inside the cavity 101.

Due to the pressure built up inside the cavity 101, once the breakable area 130 is broken, the water vapor is expelled with extreme speed to cover a large volume of space in a short period of time. Although the breakable area 130 is designed to be broken, it is also sufficiently sturdy and stable enough to withstand the pressure and temperature exerted upon it from inside the cavity 101 before being broken.

An area 130 of the container 102 may be compromised or made frangible, relative to the container 102, so as to be breakable by a variety of different means. For example, the breakable area 130 may be a thinner or thinned-out portion of the container 102. As another example, the breakable area 130 may comprise a plurality of etchings or score lines carved or formed into the area, such as a series of concentric circles (like a bull's eye) or a series of lines converging at a single point (i.e. forming wedges or triangular shapes). In some embodiments, the breakable area 130 may be an orifice covered with a breakable cap or closure. For example, the orifice through which the water is added into the cavity and the associated cap may serve as the breakable area 130. The cap covering the orifice may be made of a thinner piece of metal than the rest of the container 102 or the cap may be etched or scored. Alternatively, the cap may be made from a material different from the container 102 that can be pierced by the projectile 106 while maintaining its integrity under the imposed temperature and pressure prior to being pierced.

In some embodiments, the cap may be replaceable. For example, the external perimeter of the cap and the associated boundary defining the orifice can be threaded so that the cap can be screwed onto the container 102 at the orifice. In some embodiments, a bayonet-type lock may be used due to the high pressure built up inside. The area defining the orifice may comprise a flange for the bayonet-type lock to fasten on to. Gaskets may be used at any orifice to maintain an impermeable seal where necessary. In the embodiments with replaceable caps, the container 102 is reusable since the cap can simply be replaced after it has been broken.

In some embodiments a valve may be utilized to cover the orifice. The valve can be easily opened electronically or mechanically through high impact force.

In the preferred embodiment, all orifices in the container 102 are closed and welded shut to minimize or eliminate any leakage.

In the preferred embodiment, the container 102 is cylindrical in shape having a first end 108 and a second end 110 opposite the first end 108. The ends 108, 110 may be hemispheric, thereby forming a capsule-like container as shown in FIG. 1. The first end may contain the heating element 116 and the temperature monitor 118. The second end 110 may contain breakable area 130 and the discharge tube 104.

To improve the portability of the fire suffocating apparatus 100, in some embodiments, the container may have a handle (not shown). In addition, since only a relatively small volume of water would be required to suffocate a house fire, the size of the container can be configured to hold between half a gallon and ten gallons of water. Preferably, the container is configured to hold between one and six gallons. In some instances, a four gallon container can suffice. Containers greater than ten gallons can be used; however, this merely reduces the portability.

The discharge tube 104 is connected or formed at the second end 110 in operative communication with the breakable area 130. Therefore, when the breakable area 130 is broken open, the water escapes the container 102 into the discharge tube 104.

In the preferred embodiment, the discharge tube 104 is a hollow cylindrical tube comprising a plurality of holes 134. The discharge tube 104 has a proximal end 124 and a distal end 126 opposite the proximal end 124. The proximal end 124 of the discharge tube 104 has an opening and connects to the second end 110 of the container 102 at the breakable area 130 as shown in FIG. 3. Thus, when the breakable area 130 is broken open, the fire suffocating agent inside the cavity 101, such as water, can enter into the discharge tube 104. The distal end 126 is closed off so that the water can only exit through the plurality of holes 134 around the surface of the discharge tube 104 and not through the distal end 126. This configuration prevents the fire suffocating apparatus 100 from becoming a projectile once the breakable area 130 is broken open. In some embodiments the discharge tube 104 may simply be an extension of the container. In other words, the discharge tube 104 may be integrally formed with the container 102.

The discharge tube 104 houses the projectile 106 and serves as a conduit for the release of the compressed vapor through the plurality of holes 134. The projectile 106 is positioned at the distal end 126 of the discharge tube 104 to allow it to gain speed and momentum as it travels towards the breakable area 130 to gain sufficient force to break open the breakable area 130.

Once the breakable area 130 is broken open, the high pressure and temperature inside the cavity 101 expels the water from the cavity 101 and propels the projectile 106 back to the distal end 126 of the discharge tube 104. The water then enters into the discharge tube 104 and is expelled through the plurality of holes 134 in the discharge tube 104. Due to the quantity and profuse distribution of the holes 134 around the discharge tube 104, the container 102 itself does not become a dangerous projectile.

The total combined area of the hole created by the plurality of holes can be configured so as to expel the entire contents of the container 102 in a specified period of time. For example, the number and size of the holes can be configured so as to empty a specific volume of water in a specified period of time, particularly, within a matter of a few seconds.

The projectile 106 is configured to quickly traverse the distance of the discharge tube 104 and impact the breakable area 130 with sufficient force to break open the breakable area 130. In some embodiments, the projectile 106 may be an elongated object with a sharp tip 300 pointed towards the breakable area 130. In another example, the projectile 106 may be bullet-shaped. These configurations facilitate the projectile 106 piercing through the breakable area 130.

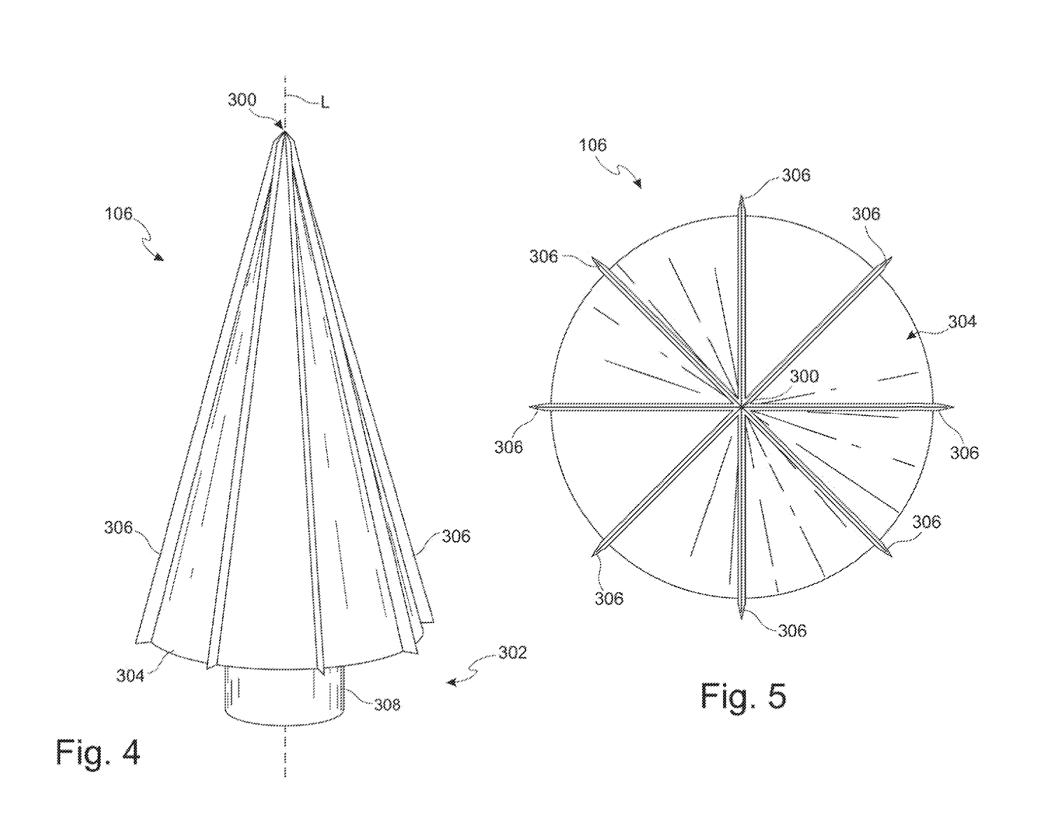

As shown in FIGS. 4 and 5, in some embodiments, the projectile 106 may be conical in shape defining a longitudinal axis L from the tip 300 of the cone, through the center, to the base 302 of the cone. In the preferred embodiment, the cone-shaped projectile 106 further comprises a plurality of blades 306 surrounding the surface 304 of the projectile 106. The blades 306 further facilitate breakage of the breakable area 130 by introducing a cutting or slicing action in addition to the piercing action by the sharp point 300.

The blades 306 lie along the surface 304 of the cone in the longitudinal direction and emerge radially away and parallel to the surface 304 of the cone. Therefore, the blades 306, like the cone-shaped projectile 106, taper from the base 302 of the cone, converging at the tip 300. In some embodiments, to further facilitate breakage of the breakable area 130, the blades 306 may spiral up the cone from the base 302 to the tip 300. The spiraling blades would allow the projectile 106 to rotate through the discharge tube 104, thereby generating a drilling action as the projectile 106 impacts the breakable area 130.

A propellant 308, such as a small explosive charge, detonator, or any other device, composition, or means for generating an explosive force to propel the projectile 106, is positioned at the base of 308 the projectile 106 at the distal end 126 of the discharge tube 104. Actuation of the propellant 308 causes the projectile 106 to propel towards the breakable area 130 of the container 102 causing the breakable area 130 to rupture. The pressure inside the container 102 then forces the projectile 106 back to the distal end 126 of the discharge tube 104. Once in the discharge tube 104, the water continues to escape through the plurality of holes 134 in the discharge tube 104 and instantly vaporize, thereby filling up the room in which the container 102 was positioned.

In some embodiments, rather than utilizing the projectile 106, the propellant 308 itself may be positioned adjacent to or directly abutting the breakable area 130 to serve as the means for breaking the breakable area 130. In this embodiment, the propellant 308 creates an explosive force sufficient to break open the breakable area 130 without destroying other portions of the fire suffocating apparatus 100. In some embodiments, the fire suffocating apparatus 100 may comprise a plurality of breakable areas 130, each breakable area 130 having its own propellant 308. These propellants 308 can be configured to explode simultaneously. Each breakable area 130 may have associated with it a discharge tube 104 to prevent the container 102 from becoming a projectile itself. In addition, each breakable area 130 may be strategically positioned opposite one other breakable area 130 so that the forces created by vapors escaping one breakable area 130 counteracts the forces created by vapors escaping the opposite breakable area 130 to further minimize the possibility of the container 102 becoming a projectile.

The propellant 308 may be actuated in a variety of ways, such as an electrical signal, a wireless signal, a physical force, a predetermined temperature, an ignition, a spark, and any other type of signal.

As a safety feature, the fire suffocating apparatus may further comprise a shell 122 surrounding the container 102. The shell 122 comprises numerous holes 132 generously distributed throughout the surface of the shell 122. The size of the holes 132 can be any size that allows the water vapor to escape quickly. The shell 122 provides a safety mechanism in case the container 102 breaks, punctures, cracks, or is otherwise compromised and releases the fire suffocating agent. Due to the high pressure built up inside the container 102, an undesired break could result in the container becoming a projectile. Having the shell 122 surround the container 102 allows the escaping gas to hit the shell 122 and dissipate out the plurality of holes 132 in the shell 122 in an even manner, thereby dissipating or otherwise counteracting any type of unidirectional force.

In the preferred embodiment, the shell 122 parallels the shape of the container 102, but is slightly larger than the container so as to completely enclose the container 102. The shell 122 comprises an orifice at the second end through which the discharge tube 104 can protrude. In some embodiments, the discharge tube 104 may be attached to or be integrally formed with the shell 122 instead of the container 102.

The shell 122 may further comprise a means for receiving the container. For example, the shell 122 may be constructed in two pieces that can be fastened together. In one example, the shell 122 may be two longitudinal pieces or two pieces cut along a plane parallel to the longitudinal axis A of the shell 122. Once the container 102 is placed into the shell 122 the two pieces of the shell may be fastened together by clamps, nuts and bolts, welding, or any other type of fastener. In another example, the shell 122 may be cut in cross-section or through a plane perpendicular to the longitudinal axis. The two pieces of the shell 122, 123 may be threaded so as to fit together like a screw-cap. Alternatively, clamps, nuts and bolts, welding, or any other type of fastener may be used.

Thus, in use, the fire fighter can insert the discharge tube 104 into a burning room, house, building, and the like, without having to step foot inside the burning structure himself. The projectile 106 can be detonated to puncture a hole in the container 102. Due to the high pressure content of the container 102 the water vapor is expelled out of the container 102 at a high rate of speed to displace the oxygen and suffocate the fire. The fire suffocating apparatus is designed to be used in enclosed areas where interior temperatures exceed 212° F. At any lower temperature the vapor will condense into steam.

In some embodiments, the fire fighter can detach the temperature monitor 118 and heating element 116 or simply unplug the wires 117, 119 connected to the temperature monitor 118 and heating element 116. The fire suffocating apparatus 100 can be sent into a burning house, building, room, or some other enclosed space. In one example, the propellant 308 can be actuated by the firefighter with a remote control to send a wireless signal to actuate the propellant 308. In another example, the temperature of the burning place can actuate the propellant 308. In another example, a cable or chain may be attached to the propellant 308. Once the fire suffocating apparatus 100 is in place, the fire fighter can pull the cable or chain to create the spark, ignition, force, reaction, or other signal required to actuate the propellant 308.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

1. A fire suffocating apparatus, comprising:
a. a cylindrical container, the cylindrical container comprising:
i. a first wall defining a cavity, the cavity containing water heated to a temperature of up to 1200° F. and pressurized up to 3200 pounds per square inch;
ii. a second wall enclosing the first wall, wherein the first wall and the second wall define a vacuum space;
iii. a first end comprising a first orifice, a second orifice, an immersion heater insertable into the first orifice, a thermocouple insertable into the second orifice, and a controller operatively coupled to the thermocouple and immersion heater to maintain a desired temperature inside the cylindrical container; and
iv. a second end opposite the first end, the second end comprising a third orifice sealed with a cover;
b. a discharge tube defining a longitudinal axis, the discharge tube comprising:
i. a proximal end connected to the second end of the cylindrical container,
ii. a distal end opposite the proximal end, and
iii. a plurality of holes intermittently spaced apart;
c. a projectile housed inside the discharge tube capable of being propelled along the longitudinal axis towards the cylindrical container, the projectile, comprising:
i. a sharp tip,
ii. a base opposite the sharp tip,
iii. a conical surface tapering from the base to the sharp tip, and
iv. a plurality of blades extending from the base and converging at the tip, the plurality of blades being parallel to and projecting radially away from the conical surface, and
v. a detonator positioned at the base, the detonator capable of propelling the projectile towards the cylindrical container; and
d. a shell enclosing the cylindrical container, the shell comprising a plurality of holes distributed throughout the shell.

2. A fire suffocation device, comprising:
a. a container defining a cavity containing water, the container comprising a breakable area;
b. a tube defining a longitudinal axis, the tube comprising:
i. a proximal end connected to the container at the breakable area,
ii. a closed, distal end opposite the proximal end, and
iii. a plurality of holes intermittently spaced apart between the proximal end and the distal end; and
c. a means for breaking the breakable area.

3. The fire suffocation device of claim 2, wherein the means for breaking the breakable area comprises a projectile housed inside the tube capable of being propelled along the longitudinal axis towards and rupturing the breakable area.

4. The fire suffocation device of claim 3, wherein the projectile, comprises:
a. a sharp tip,
b. a base opposite the sharp tip, and
c. a propellant positioned at the base, the propellant capable of propelling the projectile towards the container.

5. The fire suffocating apparatus of claim 4, wherein the projectile is cone-shaped and comprises a conical surface tapering from the base to the sharp tip.

6. The fire suffocating apparatus of claim 5, wherein the projectile comprises a plurality of blades extending from the base and converging at the tip, the plurality of blades being parallel to and projecting radially away from the conical surface.

7. The fire suffocation device of claim 2, wherein the pressure container is a double-walled container, comprising an inner wall and an outer wall, wherein the inner wall and outer wall define a vacuum space therebetween.

8. The fire suffocation device of claim 2, further comprising a means for maintaining the water at a desired pressure and temperature.

9. The fire suffocation device of claim 8, wherein the means for maintaining the water at the desired pressure and temperature comprises:
a. a heating element to heat the water;
b. a temperature monitor to measure the temperature inside the cavity; and
c. a controller operatively coupled to the heating element and the temperature monitor to actuate the heating element when the temperature inside the cavity falls below the desired temperature.

10. The fire suffocation device of claim 2, further comprising a shell enclosing the container, the shell comprising a plurality of holes distributed throughout the shell.

11. The fire suffocation device of claim 2 wherein the breakable area is a cap sealing an orifice on the container.

12. A method of suffocating a fire, comprising:
a. exposing fire to water vapor; and
b. displacing oxygen around the fire with water vapor, whereby the fire is suffocated.

13. The method of claim 12, further comprising transforming liquid water into water vapor.

14. The method of claim 12, further comprising expelling water from a pressurized container.

15. The method of claim 14, expelling water from a pressurized container via a discharge tube, wherein the discharge tube comprises a plurality of holes through which water vapor is expelled.

16. The method of claim 15, further comprising:
a. propelling a projectile that is housed in the discharge tube towards the pressurized container; and
b. breaking the pressurized container at a breakable area with the projectile.

17. The method of claim 15, wherein the projectile is cone-shaped and comprises a conical surface tapering from the base to the sharp tip.

18. The method of claim 17, wherein the projectile comprises a plurality of blades extending from the base and converging at the tip, the plurality of blades being parallel to and projecting radially away from the conical surface.

19. The method of claim 14, wherein the pressurized container is a double-walled container, comprising an inner wall and an outer wall, wherein the inner wall and outer wall define a vacuum space there between.

20. The method of claim 14, further comprising:
a. heating an interior of the pressurized container to a temperature of at least approximately 1200° F.; and
b. pressurizing the interior of the pressurized container to at least approximately 3200 pounds per square inch.
